(19) United States
(12) Patent Application Publication
(10) Pub. No.: US 2022/0055325 A1
(43) Pub. Date: Feb. 24, 2022

(54) METHOD AND MANUFACTURING SYSTEM FOR MANUFACTURING AN OPTICAL LENS

(71) Applicant: ESSILOR INTERNATIONAL, Charenton-Le-Pont (FR)

(72) Inventors: Olivier ROUSSEL, Charenton-Le-Pont (FR); Jean-Marc PADIOU, Charenton-Le-Pont (FR); Mathieu FEUILLADE, Charenton-Le-Pont (FR); Alexandre GOURRAUD, Charenton-Le-Pont (FR); Loïc QUERE, Charenton-Le-Pont (FR)

(21) Appl. No.: 17/299,549

(22) PCT Filed: Dec. 3, 2019
(86) PCT No.: PCT/EP2019/083527

§ 371 Date: Jun. 3, 2021

(30) Foreign Application Priority Data
Dec. 4, 2018 (EP) 18306613.3

(51) Int. Cl. B29D 11/00; G02C 7/02; B33Y 10/00; B33Y 30/00; B33Y 80/00

(52) U.S. Cl. CPC B29D 11/00009; G02C 7/022; B33Y 80/00; B33Y 30/00; B33Y 10/00

(57) ABSTRACT

A method for manufacturing an optical lens having at least a reference optical power at a given point is described. This method includes the steps of: selecting, among a fixed number of optical elements, one optical element to manufacture the optical lens, the step of selecting being executed as a function of the reference optical power at the given point of the optical lens, the step of selecting being executed such that the selected optical element has an optical power having an absolute value lower than or equal to the absolute value of the reference optical power at the given point of the optical lens; and manufacturing the optical lens using an additive manufacturing technology by depositing a complementary portion on the selected optical element. A manufacturing system for manufacturing an optical lens is also described.

### TECHNICAL FIELD OF THE INVENTION

The invention relates to the manufacturing of optical lenses in general and particularly ophthalmic lenses.

More precisely the invention relates to a method and a manufacturing system for manufacturing an optical lens using an additive manufacturing technology.

### BACKGROUND INFORMATION AND PRIOR ART

Using an additive manufacturing technology to manufacture an optical lens, and particularly an ophthalmic lens, is of interest because the obtained optical lens is directly shaped to fit the frame that shall carry the optical lens and/or the obtained optical lens complies with the wearer's optical prescription.

However, manufacturing a complete optical lens layer by layer by additive manufacturing consumes a significant amount of time.

The build over technology is suggested to face this constraint. It consists in adding material, by additive manufacturing, on an existing optical element in order to manufacture the optical lens.

### SUMMARY OF THE INVENTION

The present invention provides a method for manufacturing an optical lens using an additive manufacturing technology. The method aims at improving the efficiency of the manufacturing of the optical lens by additive manufacturing.

More precisely, the invention consists in a method for manufacturing an optical lens having at least a reference optical power at a given point. The method comprises the steps of:
selecting, among a fixed number of optical elements, one optical element to manufacture the optical lens, said step of selecting being executed as a function of the reference optical power at the given point of the optical lens, said step of selecting being executed such that the selected optical element has an optical power having an absolute value lower than or equal to the absolute value of the reference optical power at the given point of the optical lens, and
manufacturing the optical lens using an additive manufacturing technology by depositing a complementary portion on the selected optical element.

Thanks to the invention, the optical element used for manufacturing the optical lens is selected among a restricted group of optical elements. This restricted group of optical elements thus allows the minimization of the number of available optical elements for the manufacturing. Selecting an appropriate optical element then allows the limitation of added material to manufacture the optical lens.

Other advantageous features of the method are the following ones:
the optical power is a spherical power;
the optical power is a cylindrical power;
at least one of the fixed number of optical elements has a non null cylindrical power;
the fixed number of optical elements comprises a first optical element and a second optical element having respectively a first optical power and a second optical power, the second optical power being different from the first optical power;
the selected optical element comprises a first face and a second face, the complementary portion being deposited on at least one of the first face or the second face;
the first face and the second face of the selected optical element have respectively a first curvature and a second curvature, the first curvature being lower than the second curvature, the complementary portion being deposited on the first face;
the first face of the selected optical element is concave, said first face remaining substantially concave during the step of manufacturing;
the first face of the selected optical element is convex, said first face remaining substantially convex during the step of manufacturing;
at least one of the fixed number of optical elements comprises a first face and a second face having respectively a first vergence and a second vergence, the sum of the first vergence and the second vergence being at least substantially equal to zero;
at least one of the fixed number of optical elements is aspherical or toric or has a progressive surface or a progressive optical power distribution.

The invention also comprises a manufacturing system for manufacturing an optical lens having a reference optical power at a given point. The manufacturing system comprises:
a selection unit designed to select an optical element among a fixed number of optical elements and as a function of the reference optical power at the given point of the optical lens, said selection unit being configured such that the selected optical element has an optical power having an absolute value lower than or equal to the absolute value of the reference optical power at the given point of the optical lens, and
a manufacturing unit designed to manufacture the optical lens using an additive manufacturing technology by depositing a complementary portion on the selected optical element.

### DETAILED DESCRIPTION OF EXAMPLE(S)

The following description, given with regard to the appended drawings, which are given by way of non-limiting examples, will allow what the invention consists of and how it can be carried out to be understood.

In the appended drawings:

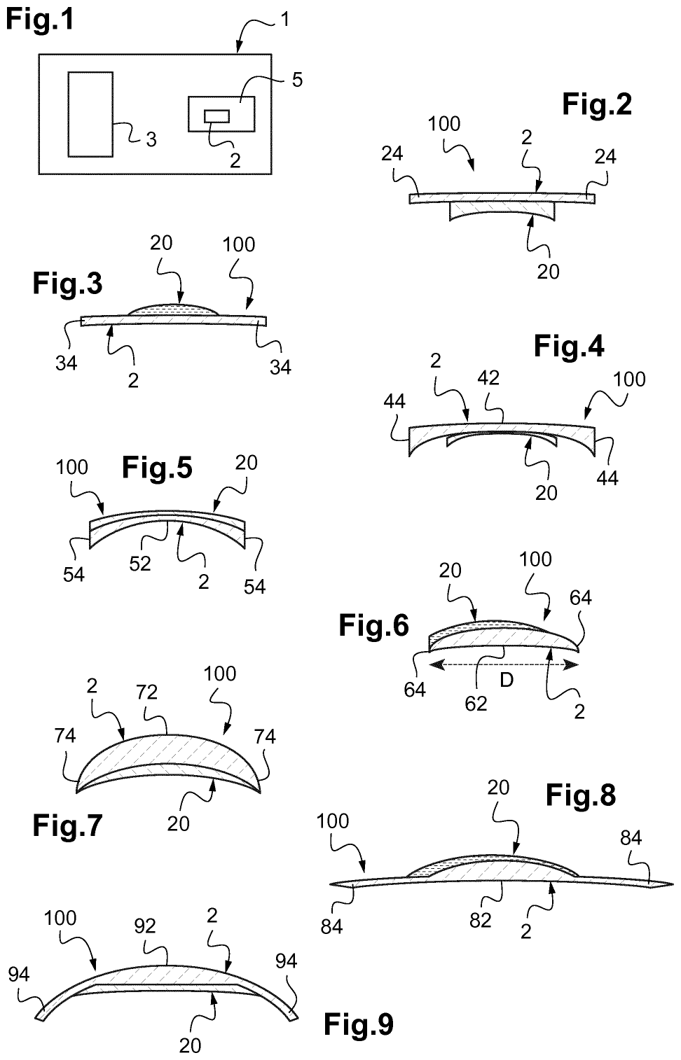

FIG. 1 shows an exemplary manufacturing system adapted to manufacture an optical lens according to the invention;

FIGS. 2 and 3 show a first embodiment of an optical element according to the invention;

FIG. 4 shows a second embodiment of an optical element according to the invention;

FIG. 5 shows a third embodiment of an optical element according to the invention;

FIGS. 6, 7, 8 and 9 show a fourth embodiment of an optical element according to the invention;

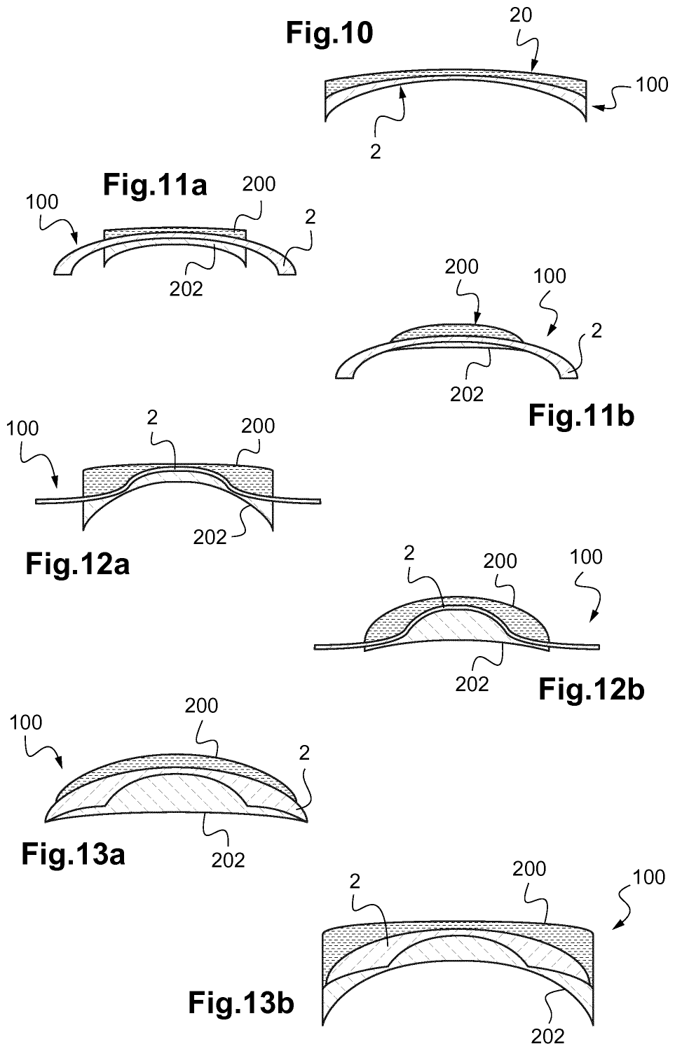

FIG. 10 shows a fifth embodiment of an optical element according to the invention; and

FIGS. 11a, 11b, 12a, 12b, 13a and 13b show a sixth embodiment of an optical element according to the invention.

FIG. 1 shows a manufacturing system 1 adapted to manufacture an optical lens. In the example described here, the optical lens is an ophthalmic lens. As an alternative, the optical element can be a component of an ophthalmic lens, for example a wafer in the case of an electrochromic lens.

The manufacturing system 1 comprises a device 3 and a support 5. The device 3 is suitable for manufacturing the optical lens using an additive manufacturing technology. The expression “additive manufacturing technology” refers to processes that manufacture solid objects by juxtaposing volume elements or voxels. In the case of the present invention, the optical lens is thus manufactured by adding volume element by volume element, layer by layer on an optical element 2. In practice, the volume can be added directly on the optical element 2. As an alternative, the added volume can be manufactured separately and then laminated on the optical element. The additive manufacturing technology may be in practice stereolithography (SLA) or polymer jetting (or inkjet printing). Preferably, polymer jetting is used.

The device 3 comprises a control unit (not shown in FIG. 1). This control unit includes a microprocessor and a memory. The memory stores instructions that allow the manufacturing system 1 to implement a method for manufacturing the optical lens as described below when these instructions are executed by the microprocessor. In particular, the memory stores data characterising the optical element 2. These data also comprise data defining a complementary portion 20 to deposit on the optical element 2 to form the optical lens 100 from the optical element 2.

The manufacturing system 1 also comprises an assembly of units (not represented), such as a selection unit and a manufacturing unit. These units are in practice made with a combination of hardware elements and software elements. Each unit implements a function described in the method according to the invention and explained below. For each unit, the manufacturing system 1 stores for example software instructions that can be implemented by the microprocessor in order to use a material element and thus execute the function associated to the concerned unit.

The optical element 2 is obtained before the implementation of the method according to the present invention. As an example, the optical element 2 can be obtained by being manufactured by different methods such as moulding or additive manufacturing. As another example, the optical element 2 can be an active optical see-through component. As an example, the active optical see-through component can be an electrochromic cell used for an encapsulation electrochromic solution. More details on electrochromic cells included in ophthalmic lenses can be found for instance in document US2018/0196283. As another example, the active see-through component can be an augmented-reality device or any electro-active component.

In practice, the optical element 2 comprises different material having different refractive index. The optical element 2 can also comprise non-clear substrate (such as photochromic, polar wafer or tinted substrate) or another element deposited on the optical element 2, such as hard coat. This other element may in practice be deposited on a face of the optical element 2 different from the face on which the complementary portion 20 is printed.

The optical element 2 is the base element for manufacturing the optical lens 100. The optical element 2 is a part of the final optical lens. In other words, the optical element 2 is included in the optical lens 100, for example between a front face and a second face of the optical lens 100. As an alternative, the optical element 2 can be a part of one of the front face or the back face of the optical lens 100.

The optical element 2 is designed to have some properties required for defining the optical lens 100. As an example, the optical element 2 is transparent.

The optical element 2 is selected to be consistent with a prescription of a wearer even if it does not provide the exact correction expected for the optical lens 100 (here as already mentioned an ophthalmic lens). In particular, the prescription of the wearer comprises a reference optical power at a given point of the optical lens 100 (here an ophthalmic lens) used for manufacturing the optical lens 100. The reference optical power at the given point is positive or negative. As an example, the reference optical power at the given point can correspond to a far vision prescription (the given point corresponding to a far vision area). As another example, the reference optical power at the given point can be evaluated as the absolute value of the maximal value of optical power expected over the whole optical lens 100.

In practice, the prescription comprises data regarding an optical power of the optical lens (here the ophthalmic lens). According to some embodiments, the optical power can be constant over the whole optical lens. As an alternative, the optical power can be locally constant in the optical lens 100, for instance at a defined geometrical or optical centre of the optical lens 100. As another alternative, the optical power can vary along the optical lens 100.

However, the optical element 2 may not be fully configured with all the attributes needed to be compatible with the requested prescription of a wearer or may not be shaped with the final lens outline desired for mounting it in a frame. In particular, the optical element 2 has an optical power which may in some regions be different from the reference optical power of the optical lens 100. The optical power difference between the optical element 2 and the optical lens 100 is then compensated during the manufacturing process. In this specification, the optical power is a spherical power or a cylindrical power.

According to a first embodiment shown in FIGS. 2 and 3, the thickness of the optical element 2 is substantially the same along the optical element 2. In practice, a set of thickness thresholds for the optical lens 100 can be defined to allow for mechanical resistance or post-treatments of an edge of the optical lens 100 (thus including the optical element 2 and the complementary portion 20). In order to control the final thickness of the optical lens, the thickness of the optical element 2 needs to be limited. In practice here, the thickness of the optical element 2 is (strictly) lower than the minimum of the thickness thresholds included in the set of thickness thresholds for the optical lens 100. In order to satisfy a compromise between the restriction in terms of thickness of the optical element 2 and the mechanical resistance of the optical lens 100, the thickness of the optical element 2 is for example greater than 0.3 millimetres (mm), for instance between 0.3 mm and 1 mm, here around 0.5 mm.

In this first embodiment, a curvature of this optical element 2 is substantially flat. The first embodiment is for example adapted to an emmetropic vision. It can also be adapted for a myopic vision (FIG. 2) or a hyperopic vision (FIG. 3).

According to a second embodiment represented in FIG. 4, the optical power of the optical element 2 is negative. The optical element 2 is thinner at its centre 42 than at its edges 44. This second embodiment is for example suitable for a myopic vision. As an alternative, the optical element 2 can also comprise a cylinder on one of its surface.

According to a third embodiment represented in FIG. 5, the optical power of the optical element 2 is negative. The optical element 2 is thinner at its centre 52 than at its edges 54. Preferably, the thickness of the optical element 2 at its centre is substantially equal to 1 mm.

In this embodiment, the optical element 2 has a non-null curvature. As an alternative, the optical element 2 can also comprise a cylinder on one of its surface. This third embodiment is also suitable for a myopic vision.

FIG. 6 and FIG. 7 represent a fourth embodiment for the optical element 2. In this case, the optical power of the optical element 2 is positive. The optical element 2 is larger at its centre 62, 72 than at its edges 64, 74. In practice, distinct optical elements 2 can have different diameters D in order to minimize the thickness of the edges 64, 74. For instance, the optical element 2 used for the manufacturing of the optical lens can be the one with a diameter D that can match a final contour of the optical lens.

The thickness of the edges 64, 74 is preferably lower than 1 mm. In practice, the thickness of the edges 64, 74 is substantially equal to 0.3 mm or 0.5 mm.

This fourth embodiment is for example suitable for a hyperopic vision.

As an alternative represented in FIGS. 8 and 9, the optical element 2 can comprises external areas 84, 94 and central part 82, 92. The central part 82, 92 has a positive optical power. The thickness of the external areas 84, 94 remains substantially constant. Preferably, the thickness of the external areas ranges between 0.3 mm and 0.5 mm.

FIG. 10 shows a fifth embodiment of the optical element 2. In this case, the optical element 2 is toric or aspherical. As an alternative, the optical element 2 can have a first toric face and a second aspherical face (both shapes are associated). This fifth embodiment is adapted to a wearer who needs a progressive optical equipment.

According to a sixth embodiment represented in FIGS. 11a and 11b, the optical element 2 has a constant curvature and a constant thickness.

As an alternative, the optical element 2 can have a curved central portion and flat edges (FIGS. 12a and 12b). In this case, the optical element 2 is aspherical. As an example, the optical element 2 can have a progressive surface or a progressive optical power distribution.

As another alternative (FIGS. 13a and 13b), the thickness of the optical element 2 can vary along its extension. The curvature of the optical element 2 can also vary in this case.

The manufacturing system 1 shown in FIG. 1 and described previously is suitable to execute a method for manufacturing an optical lens 100 using the additive manufacturing technology.

Before executing this method, a group of a fixed number of optical elements is determined. Only an optical element included in this group can be used during the method for manufacturing the optical lens 100.

This group is determined in order to minimize the number of optical elements than can be used to manufacture optical lenses. The optical elements included in the group are chosen in order to reduce the manufacturing time or to reduce the added volume of material for manufacturing the optical lens.

However, the optical elements included in the group are also carefully chosen in order to be able to manufacture any lens with any prescription. In other words, the fixed number is determined as a compromise between minimizing the number of available optical elements and adding less material in the following steps.

In practice, the different embodiments for the optical element 2 previously introduced can be introduced in the group of the fixed number of optical elements. As an example, the group of the fixed number of optical elements can comprise optical elements with different optical powers, at least one optical element with a non-null cylindrical power or at least one aspherical or toric optical element. As another example, and considering that an optical element has a first face having a first vergence and a second face having a second vergence, the group of the fixed number of optical elements can comprise at least one optical element in which the sum of the first vergence and the second vergence is substantially equal to zero.

The method for manufacturing the optical lens 100 comprises a step S2 of selecting one optical element among the group of the fixed number of optical elements previously determined. As previously described, the method aims at manufacturing an optical lens 100 with a reference optical power at a given point. The selection is thus executed as a function of the optical power of the optical element 2. In practice, the selection unit included in the manufacturing system 1 selects the appropriate optical element 2 based on a comparison of the associated optical power.

The step S2 of selecting an optical element 2 is executed such that the selected optical element has an optical power having an absolute value lower than or equal to the absolute value of the reference optical power at the given point of the optical lens 100. In practice, the selected optical element can be the one with the highest absolute value of the optical power which still remains lower than the absolute value of the reference optical power at the given point of the optical lens 100.

The method continues with a step S4. During this step, a complementary portion 20 is deposited on the selected optical element in order to manufacture the optical lens 100. The deposition of the complementary portion 20 is executed using the additive manufacturing technology.

In practice, considering the first face and the second face of the selected optical element, the complementary portion 20 is deposited on at least one of the first face and the second face. As an alternative, the complementary portion 20 can be deposited on both first and second faces of the selected optical element.

According to the invention, various embodiments for the step S4 of depositing can be distinguished. The different embodiments for the step S4 are based on the previous embodiments introduced for the optical elements.

If the selected optical element is one of the previous first and second embodiments (shown in FIGS. 2 and 4) and suitable for myopic vision, the complementary portion 20 is deposited on one of the faces of the selected optical element. As an example, if the first face is a back face of the selected optical element and the second face is a front face of the selected optical element, the complementary portion 20 is here deposited on the back face of the selected optical element. However, as shown in FIGS. 2 and 4, the complementary portion 20 is not deposited on the whole back face of the selected optical element. The edges 24, 44 of this selected optical element are preserved in order to mount the optical lens 100 (here as already mentioned an ophthalmic lens) in a frame.

In practice, the complementary portion 20 is printed in such a way to minimize the thickness of the centre of the optical lens 100. The step S4 of manufacturing thus depends on the thickness of the complementary portion 20 that should be added on the selected optical element.

As an alternative, if the selected optical element corresponds to the third embodiment represented in FIG. 5 (and also suitable for myopic vision), the complementary portion 20 is deposited on the front face of the selected optical element. As the optical power of the selected optical element is negative and is lower than the reference optical power at the given point, the complementary portion 20 has thus a negative optical power. In practice, this condition involves a reduction of the curvature of the face on which the complementary portion 20 is deposited (here the front face of the selected optical element).

In practice, the thickness of the deposited complementary portion 20 can be evaluated in order to compensate a cylindrical component which can be included in the back face for aesthetic reasons.

If the selected optical element is one of the previous first and fourth embodiments (shown in FIGS. 3, 6 and 8) and suitable for hyperopic vision, the complementary portion 20 is deposited on one of the faces of the selected optical element. As an example, the complementary portion 20 is here deposited on the front face of the selected optical element.

In practice, the complementary portion 20 is printed in such a way to minimize the thickness of the edges of the optical lens 100 while keeping a predetermined distance between the back surface of the optical lens (here the ophthalmic lens) and an eye of a wearer.

As an alternative, if the selected optical element corresponds to the fourth embodiment represented in FIGS. 7 and 9 (and also suitable for hyperopic vision), the complementary portion 20 is deposited on the back face of the selected optical element. In practice, considering that the first face and the second face of the selected optical element have respectively a first curvature and a second curvature, and that the first curvature being lower than the second curvature, the complementary portion 20 is deposited on the first face. Here the first face corresponds to the back face. In other words, the complementary portion 20 is deposited on the face with the lowest curvature.

In this case, the back face of the selected optical element is concave. The deposition of the complementary portion 20 does not change the global curvature and the back face remains concave during the step S4 of manufacturing. However, this back face can be locally convex, for example for progressive optical lenses.

As another alternative (not represented), the back face of the selected optical element can be convex. In this case, the deposition of the complementary portion 20 does not change the global curvature and the back face remains convex during the step S4 of manufacturing. However, this back face can be locally concave.

If the selected optical element corresponds to the previous fifth embodiment (shown in FIG. 10) and suitable for a progressive vision, the complementary portion 20 is deposited on one of the face of the selected optical element, here on the front face of the selected optical element.

As an alternative, the back surface of the selected optical element can include a toric component. This toric component is selected in order to minimize the volume of the added material (of the complementary portion).

In practice, all the previous introduced embodiments can include a cylindrical component in one of the faces of the selected optical element in order to satisfy aesthetical conditions. For example, in the case of a myopic vision, a small cylindrical component can be included in the front face. This small cylindrical component ranges for example from 0.25 to 1 dioptres. However, the lowest cylindrical component should be included for a hyperopic vision.

In practice, a toric optical element can be used in order to make easier the manufacturing of the optical lens, especially with high cylindrical component.

If the selected optical element corresponds to the previous sixth embodiment (shown in FIGS. 11a, 11b, 12a, 12b, 13a and 13b), the complementary portion 20 includes two parts, a first part 200 and a second part 202. The first part 200 is for example deposited on the front face and the second part 202 is printed on the back face. These configurations allow the manufacturing of great optical power ranges of optical lenses.

1. Method for manufacturing an optical lens having at least a reference optical power at a given point, the method comprising the steps of:
selecting, among a fixed number of optical elements, one optical element to manufacture the optical lens, said step of selecting being executed as a function of the reference optical power at the given point of the optical lens, said step of selecting being executed such that the selected optical element has an optical power having an absolute value lower than or equal to the absolute value of the reference optical power at the given point of the optical lens, and
manufacturing the optical lens using an additive manufacturing technology by depositing a complementary portion on the selected optical element.

2. The Method for manufacturing an optical lens according to claim 1, wherein the optical power is a spherical power.

3. The Method for manufacturing an optical lens according to claim 1, wherein the optical power is a cylindrical power.

4. The Method for manufacturing an optical lens according to claim 1, wherein at least one of the fixed number of optical elements has a non null cylindrical power.

5. The Method for manufacturing an optical lens according to claim 1, wherein the fixed number of optical elements comprises a first optical element and a second optical element having respectively a first optical power and a second optical power, the second optical power being different from the first optical power.

6. The Method for manufacturing an optical lens according to claim 1, wherein the selected optical element comprises a first face and a second face, the complementary portion being deposited on at least one of the first face or the second face.

7. The Method for manufacturing an optical lens according to claim 6, wherein the first face and the second face of the selected optical element have respectively a first curvature and a second curvature, the first curvature being lower than the second curvature, the complementary portion being deposited on the first face.

8. The Method for manufacturing an optical lens according to claim 7, wherein the first face of the selected optical element is concave, said first face remaining substantially concave during the step of manufacturing.

9. The Method for manufacturing an optical lens according to claim 7, wherein the first face of the selected optical element is convex, said first face remaining substantially convex during the step of manufacturing.

10. The Method for manufacturing an optical lens according to claim 1, wherein at least one of the fixed number of optical elements comprises a first face and a second face having respectively a first vergence and a second vergence, the sum of the first vergence and the second vergence being at least substantially equal to zero.

11. The Method for manufacturing an optical lens according to claim 1, wherein at least one of the fixed number of optical elements is aspherical or toric or has a progressive surface or a progressive optical power distribution.

12. Manufacturing system for manufacturing an optical lens having a reference optical power at a given point, the manufacturing system comprising:
a selection unit designed to select an optical element among a fixed number of optical elements and as a function of the reference optical power at the given point of the optical lens, said selection unit being configured such that the selected optical element has an optical power having an absolute value lower than or equal to the absolute value of the reference optical power at the given point of the optical lens, and
a manufacturing unit designed to manufacture the optical lens using an additive manufacturing technology by depositing a complementary portion on the selected optical element.

13. The Method for manufacturing an optical lens according to claim 2, wherein at least one of the fixed number of optical elements has a non null cylindrical power.

14. The Method for manufacturing an optical lens according to claim 3, wherein at least one of the fixed number of optical elements has a non null cylindrical power.

15. The Method for manufacturing an optical lens according to claim 2, wherein the fixed number of optical elements comprises a first optical element and a second optical element having respectively a first optical power and a second optical power, the second optical power being different from the first optical power.

16. The Method for manufacturing an optical lens according to claim 3, wherein the fixed number of optical elements comprises a first optical element and a second optical element having respectively a first optical power and a second optical power, the second optical power being different from the first optical power.

17. The Method for manufacturing an optical lens according to claim 4, wherein the fixed number of optical elements comprises a first optical element and a second optical element having respectively a first optical power and a second optical power, the second optical power being different from the first optical power.

18. The Method for manufacturing an optical lens according to claim 2, wherein the selected optical element comprises a first face and a second face, the complementary portion being deposited on at least one of the first face or the second face.

19. The Method for manufacturing an optical lens according to claim 3, wherein the selected optical element comprises a first face and a second face, the complementary portion being deposited on at least one of the first face or the second face.

20. The Method for manufacturing an optical lens according to claim 4, wherein the selected optical element comprises a first face and a second face, the complementary portion being deposited on at least one of the first face or the second face.
